(19) United States
(12) Patent Application Publication
(10) Pub. No.: US 2007/0199646 A1
(43) Pub. Date: Aug. 30, 2007

(54) Cushion assembly and a method for producing a cushion assembly

(76) Inventor: Joseph S. Wycech, Gross Pointe Farms, MI (US)

Correspondence Address: John G. Chupa;Law Offices of John Chupa and Associates, P.C., Suite 50, 28535 Orchard Lake Rd., Farmington Hills, MI, 48334, US

(21) Appl. No.: 11/796,025

(22) Filed: Apr. 26, 2007

Related U.S. Application Data
(63) Continuation-in-part of application No. 11/022,122, filed on Dec. 23, 2004.

(51) Int. Cl. B29D 31/00

(52) U.S. Cl. 156/242

(57) ABSTRACT

A cushion assembly (10) and a method (30) for making the cushion assembly (10) is disclosed and includes molding pliable core material (43) and skin material (49) within a mold (36), thereby forming the cushion assembly (10) having very desirable wear and other characteristics. In an alternate, although non-limiting methodology (300), the core material, such as material (43), is formed into a desired shape and overall geometric configuration by any desired forming methodology (e.g., by cutting with a hot knife) and then coated with skin material, such as skin material (49), by substantially any desired coating methodology (e.g., by spraying).

This application is a continuation-in-part of U.S. patent application Ser. No. 11/022,122 which was filed on Dec. 23, 2004.

### FIELD OF THE INVENTION

The present invention generally relates to a cushion assembly and to a method for producing a cushion assembly and more particularly to a method for producing a cushion assembly in a cost effective and efficient manner and which is further adapted to produce a cushion assembly having a soft pliable core and a skin which substantially encapsulates the soft pliable core and which protects the core and keeps the core dry.

### BACKGROUND OF THE INVENTION

A cushion assembly is used to provide a comfortable surface upon which to sit or otherwise recline or relax. Accordingly, a cushion assembly has a wide range of uses and applications such as and without limitation, use as part of an office furniture assembly or public seating assembly (e.g., office chairs or stadium seating) and use within a convalescent or hospital setting (e.g. as part of a hospital mattress or pillow). While current cushion assemblies do provide a comfortable surface upon which to sit or otherwise recline, they suffer from some drawbacks.

By way of example and without limitation, these current cushion assemblies are not generally waterproof or “liquid proof” and are easily damaged or destroyed due to rain, beverage spillage or contact with other liquids, such as medicine or body fluids within a hospital or medical/convalescent setting, thereby requiring costly and frequent replacement and unsanitary conditions.

Further, these current cushion assemblies are not durable and wear very quickly (e.g., quickly losing their pliableness or softness), thereby requiring costly and frequent replacement and are relatively expensive to manufacture. Further, current manufacturing techniques and strategies are not readily adapted to easily allow a variety of dissimilar cushion shapes and sizes to be made.

There is therefore a need for a new and improved method for producing a cushion assembly and a cushion assembly made by this method which overcomes some or all of the various previously delineated deficiencies associated with current cushion assemblies and cushion assembly manufacturing techniques and strategies.

### SUMMARY OF THE INVENTION

It is a first non-limiting object of the present invention to provide a method for producing a cushion assembly and a cushion assembly which overcomes some or all of the previously delineated drawbacks associated with prior cushion assemblies and methods for making cushion assemblies.

It is a second non-limiting object of the present invention to provide a method for producing a cushion assembly and a cushion assembly which overcomes some or all of the previously delineated drawbacks associated with prior cushion assemblies and methods for making cushion assemblies and, more particularly, to a method for cost effectively and efficiently producing a cushion assembly which includes a soft pliable core portion which is substantially water and liquid proofed.

It is a third non-limiting object of the present invention to provide a method for producing a cushion assembly and a cushion assembly which overcomes some or all of the previously delineated drawbacks associated with prior cushion assemblies and methods for making cushion assemblies and, more particularly, to a substantially liquid proof cushion assembly made in a cost effective and efficient manner.

According to a first non-limiting aspect of the present invention, a cushion assembly is provided and includes a foam interior portion; and a skin portion which is selectively formed upon the foam interior portion.

According to a second non-limiting aspect of the present invention, a method for forming a cushion assembly is provided and include the steps of selecting a core material; selecting a skin material; forming the core material into a desired size and shape; coating the core material with the skin material, effective to form the cushion assembly.

According to a third non-limiting aspect of the present invention, a method of forming a cushion assembly is provided and includes the steps of selecting a core material; cutting the core material with a hot knife, effective to form the core material into a desired spatial configuration with closed cell edges; selecting a skin material; spraying the skin material upon the core material, effective to substantially encapsulate the core material, thereby forming the cushion assembly.

These and other features, aspects, and advantages of the present invention will become apparent from a reading of the following detailed description of the preferred embodiment of the invention, including but not limited to the subjoined claims, and by reference to the following drawings.

### BRIEF DESCRIPTION OF THE DRAWINGS

FIG. 1 is a top view of a cushion assembly which is made in accordance with the teachings of the preferred embodiment of the invention;

FIG. 2 is a side view of the assembly which is shown in FIG. 1;

FIG. 3 is a flow chart including the sequence of steps associated with the cushion assembly forming method of the preferred embodiment of the invention;

FIG. 4 is a partial top view of a mold assembly which may be used by the methodology of the preferred embodiment of the invention;

FIG. 5 is a top view of a formed mold assembly being cut according to the methodology of the preferred embodiment of the invention; and

FIG. 6 is a flowchart which illustrates a cushion assembly forming methodology according to the teachings of an alternate and non-limiting embodiment of the invention.

### DETAILED DESCRIPTION OF THE PREFERRED EMBODIMENTS OF THE INVENTION

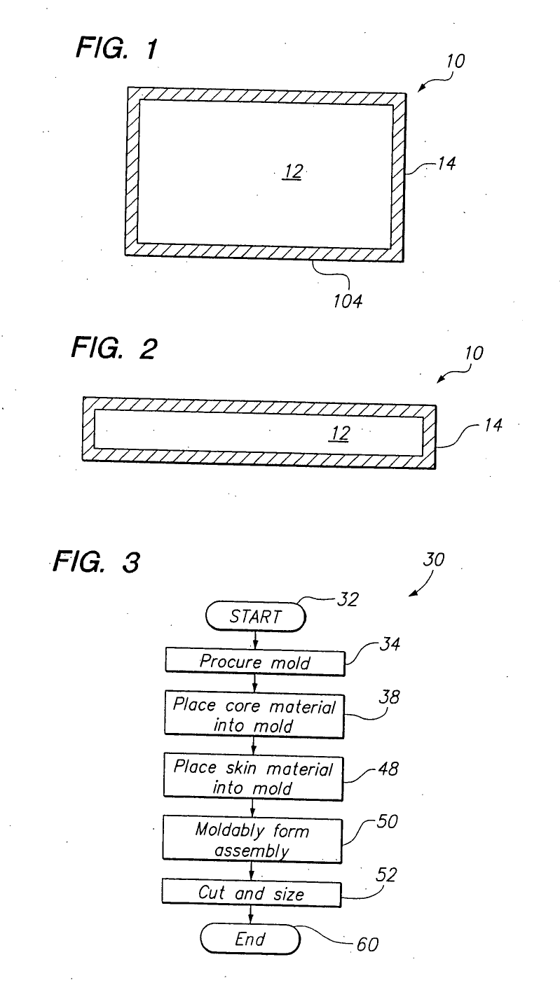

Referring now to FIGS. 1 and 2 there is shown a cushion assembly 10 which is made in accordance with the teachings of the preferred embodiment of the invention.

Particularly, the cushion assembly 10 includes a relatively pliable and soft core portion 12 which is substantially encapsulated by a skin portion 14 and the skin portion 14 acts as a substantially impenetrable barrier to generally protect the soft and pliable core portion 12 while substantially preventing water and/or other liquids from contacting the core portion 12. The skin portion 14 not only substantially “liquid proofs” the core portion 12, but it also provides strength to the overall cushion assembly 14 and provides an engagement surface with very good wear traits (i.e., the skin 14 is very durable), thereby allowing the cushion assembly 10 to wear well.

Referring now to FIG. 3, there is shown a methodology 30 which comprises a sequence of steps which cooperatively and collectively comprise the methodology of the preferred embodiment of the invention.

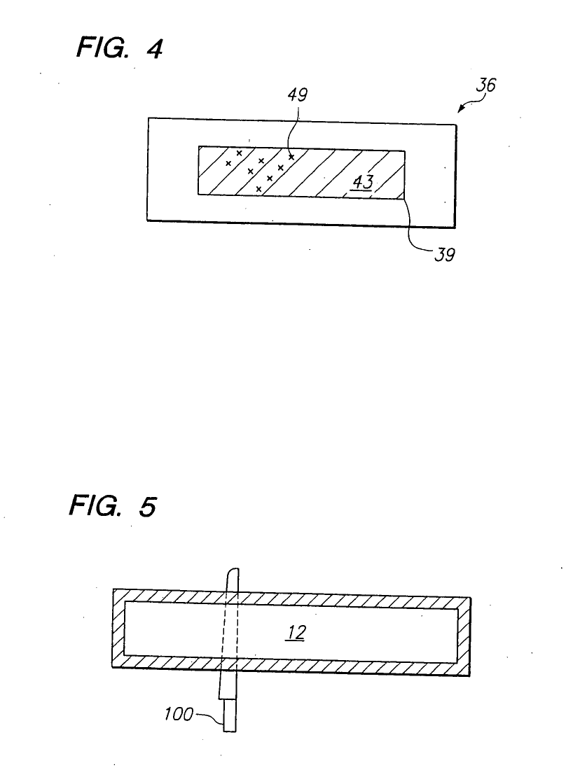

Particularly, methodology 30 includes a first step 32 which defines or delineates the overall start or initialization of the methodology 30 (i.e., which denotes the decision of the creators of the cushion assembly 10 to actually begin to form the assembly 10). Step 32 is followed by step 34 and in this step 34 a mold is procured, such as and without limitation mold 36 which is shown in FIG. 4 and which is of the type having a molding cavity 39, which is formed in a bottom portion 41. The mold 36 further has a top portion 41 which movably cooperates with the bottom portion 41 to enclose the cavity 39 and form a product within the cavity 39. Nothing in this description is meant to limit the invention to a particular type of mold or mold configuration.

Step 34 is followed by step 38 into which material 43 which is to form the core portion 12 is placed into molding cavity 39. In one non-limiting embodiment of the invention, the material 43 comprises polyester, polyethylene and/or polyurethane. Step 38 is followed by step 48 in which the skin material 49 is placed into the mold 36. In one non-limiting embodiment of the invention the skin material comprises polyurea and is placed on top of and over the previously deposited core material. In another non-limiting embodiment of the invention, the skin material is initially placed within the cavity 39 and the core material 43 is placed on top of and over the previously deposited skin material 49.

Step 50 follows step 48 and, in this step, the mold 36 is used to moldable form the cushion assembly 10 (e.g., the top selectively moves against the bottom portion 41 to cause pressure to occur within the mold cavity 39). Step 52 follows step 50 and, in this step 52, the formed cushion assembly is measured or sized to a particular length and width and then cut by a knife 100, as shown in FIG. 5, or by some other technique or methodology.

In one non-limiting embodiment of the invention, the knife 100 comprises a “hot” or heated knife which is effective to allow all of the edges, such as 104, of the formed cushion assembly 10 to be of a closed cell form. Alternatively, the knife 100 may be a “cold” knife which is effective to have these edges form an open cell arrangement.

Thus, it should be understood that the formed cushion assembly 10 has a very durable outer skin 14 and a soft and pliable core member 12 and that the outer skin 14 protects the soft and pliable core member 12 and substantially prevents water or liquid from contacting the soft and pliable core portion 12 making the soft and pliable core portion 12 substantially liquid or water proof. Further, it should be appreciated that the foregoing methodology represents a very cost effective and efficient method for producing the cushion assembly 10 and that the formed cushion assembly may have a wide variety of applications and uses, including use as a stadium seat, office seat, and hospital and convalescent mattress, and may be formed in a wide variety of sizes and shapes.

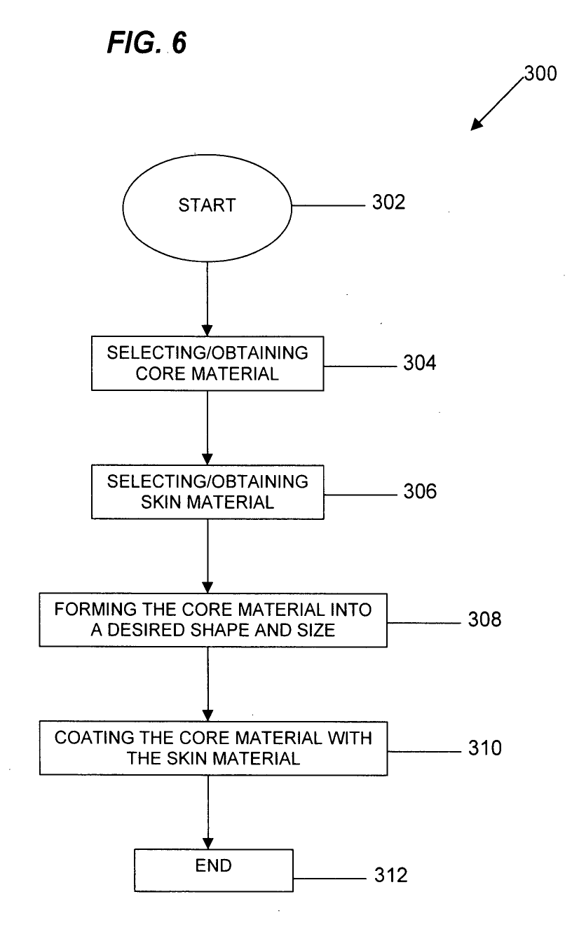

Referring now to FIG. 6, there is shown a methodology or flowchart 300 which includes a plurality of steps which cooperatively define a cushion making or “cushion assembly” forming methodology according to the teachings of another alternate embodiment of the invention.

Particularly, methodology 300 includes a first step 302 in which a user determines that it is desired to form a cushion. Step 302 is followed by step 304 in which a core or “interior” material is selected and obtained. Non-limiting examples of such a selected/obtained core material include polyester, polyethylene, and/or polyurethane types of material.

Step 306 follows step 304 and, in this step 306, a skin or “exterior” material is selected and/or obtained and non-limiting examples of such an exterior or “skin” material includes polyurethane type material.

Step 308 follows step 306 and, in this step 308, the core material is formed and shaped into a desired shape, size, and overall geometric configuration. Nothing in this methodology limits the shape or overall geometric configuration of the core material in any manner. Moreover, the core material may be formed into this desired overall geometric configuration by any desired method, such as by the use of a mold, as described earlier with respect to FIG. 3, or by cutting with a hot or cold knife until an overall desired geometric core material configuration is achieved. Other forming methodologies may be utilized. The advantage of using a hot knife to cut the core material is that it allows the cut material to have closed cell edges where it has been cut. The non-cut material edges, by the nature of the core material has “closed cell” type edges already.

Step 310 follows step 308 and, in this step 310, the core material is coated with the skin material until, in one non-limiting embodiment, it becomes substantially encapsulated with the skin material. It should be appreciated that such coating may be achieved by spraying or by any other desired coating methodology.

Step 312 follows step 310 and denotes the end of the methodology 300. It should be appreciated that, as part of either steps 310 and 312, the produced coated cushion may be further cut or trimmed with either or hot or cold knife in order to produce a final cushion assembly.

It should be further appreciated that the order of the various steps 304-310 may vary from that which is shown in FIG. 6. For example and without limitation, step 306 may actually be accomplished before or concomitantly with step 304 and by way of further example and without limitation, step 310 may actually be accomplished before or concomitantly with step 308. Nothing in this description is meant to limit the sequence of performed steps to be only that which is depicted within FIG. 6.

It is to be understood that the invention is not limited to the exact construction and embodiments which have been delineated above, but that various changes and modifications may be made without departing from the spirit and the scope of the inventions as are further delineated in the following claims.

What is claimed is:

1) A cushion assembly comprising a foam interior portion; and a skin portion which is selectively formed upon the foam interior portion.

2) The cushion assembly of claim 1 wherein said skin portion comprises polyurea.

3) The cushion assembly of claim 2 wherein said foam interior portion is pliable and conformable.

4) The cushion assembly of claim 1 wherein said skin portion comprises polyurea.

5) A method for forming a cushion assembly comprising the steps of selecting a core material; selecting a skin material; forming the core material into a desired size and shape; and coating the core material with said skin material, effective to form said cushion assembly.

6) The method of claim 5 wherein said core material comprises polyester material.

7) The method of claim 5 wherein said core material comprises polyethylene material.

8) The method of claim 5 wherein said core material comprises polyurethane material.

9) The method of claim 5 wherein said skin material comprises polyurea material.

10) The method of claim 5 wherein said step of forming said core material into a desired shape and size comprises the step of cutting said core material into said desired shape and size by the use of a knife.

11) The material of claim 10 wherein said step of coating said core material comprises the step of spraying said core material with said skin material.

12) A method of forming a cushion assembly comprising the steps of selecting a core material; cutting said core material with a hot knife, effective to form said core material into a desired spatial configuration with closed cell edges; selecting a skin material; spraying said skin material upon said core material, effective to substantially encapsulate said core material, thereby forming said cushion assembly.

13) The method of claim 12 wherein said core material comprises polyester material.

14) The method of claim 12 wherein said core material comprises polyethylene material.

15) The method of claim 12 wherein said core material comprises polyurethane material.

16) The method of claim 12 wherein said skin material comprises polyurea material.

17) The cushion assembly of claim 12 wherein said process further includes the steps of sizing and cutting the formed cushion assembly with a hot knife, effective to form closed cell edges.

18) The cushion assembly of claim 12 wherein said process further includes the steps of sizing and cutting the formed cushion assembly with a cold knife, effective to from open cell edges.
